(19) United States
(12) Patent Application Publication
(10) Pub. No.: US 2025/0365583 A1
(43) Pub. Date: Nov. 27, 2025

(54) DEVICES AND METHODS FOR MONOSTATIC SIDELINK SENSING IN A WIRELESS NETWORK

(71) Applicant: HUAWEI TECHNOLOGIES CO., LTD., Shenzhen (CN)

(72) Inventors: Richard Stirling-Gallacher, Munich (DE); Mario Hernan CASTANEDA GARCIA, Munich (DE); Anastasios Kakkavas, Munich (DE); Xitao Gong, Munich (DE); Yiqun Wu, Shanghai (CN); Xiang Ren, Shanghai (CN)

(73) Assignee: HUAWEI TECHNOLOGIES CO., LTD., Shenzhen (CN)

(21) Appl. No.: 19/288,205

(22) Filed: Aug. 1, 2025

Related U.S. Application Data
(63) Continuation of application No. PCT/CN2023/074332, filed on Feb. 3, 2023.

(51) Int. Cl. H04W 16/28; H04B 17/318; H04W 72/25

(52) U.S. Cl. CPC H04W 16/28; H04B 17/318; H04W 72/25

(57) ABSTRACT

A user equipment UE for performing monostatic sidelink sensing. The UE is configured to transmit a plurality of narrowband sidelink sensing discovery beams directed along a first plurality of transmit directions, measure a respective received signal strength of the plurality of reflected narrowband sidelink sensing discovery beams for the first plurality of transmit directions, and transmit a plurality of wideband sidelink sensing beams along a second plurality of transmit directions. The UE is further configured to determine the second plurality of transmit directions based on the first plurality of transmit directions and the plurality of received signal strengths of the plurality of reflected narrowband sidelink sensing discovery beams. Thus, the UE allows for an efficient allocation of resources for monostatic sidelink sensing.

### CROSS-REFERENCE TO RELATED APPLICATIONS

This application is a continuation of International Application No. PCT/CN2023/074332, filed on Feb. 3, 2023, the disclosure of which is hereby incorporated by reference in its entirety.

### TECHNICAL FIELD

The embodiments relate to monostatic sidelink sensing in wireless communication networks. Further, the embodiments relate to devices and methods for efficient resource allocation for monostatic sidelink sensing in a wireless network.

### BACKGROUND

Communication between mobile devices, also referred to as user equipments (UEs), has been standardized in the form of sidelink (SL) communications since release 12 of the Long-Term Evolution (LTE) of the 3rd generation partnership project (3GPP) standard. Subsequently, sidelink communications has further evolved in the 5G new radio (5G NR) standard of 3GPP. The resources for sidelink communication may either be assigned by the network, which is referred to as mode 1 resource allocation in 5G NR or the resources may be assigned in an autonomous distributed way by each UE, which is referred to as mode 2 resource allocation in 5G NR. The UE may be allowed to use the autonomous distributed resource allocation, when the network allows the UE to do so, when the UE is out of network coverage, or when it is using unlicensed spectrum

Recently, there has been significant interest in the use of the sidelink signals to perform sidelink sensing. In the case of monostatic sidelink sensing, the sensing transmitter and the receiver may be collocated, and the transmitting UE may sense its local environment based on the received reflected signal. This may require a full-duplex operation.

### SUMMARY

The embodiments provide improved devices and methods for efficient resource allocation for monostatic sidelink sensing for the case that the UE is performing autonomous resource allocation.

According to a first aspect, a user equipment (UE) which is performing monostatic sidelink sensing, is provided. The UE is configured to transmit a plurality of narrowband sidelink sensing discovery beams directed along a first plurality of transmit directions, measure a respective received signal strength, such as reference signal received power (RSRP), of the plurality of reflected narrowband sidelink sensing discovery beams for the first plurality of transmit directions and transmit a plurality of wideband sidelink sensing beams along a second plurality of transmit directions. The UE is further configured to determine the second plurality of transmit directions based on the first plurality of transmit directions and the plurality of received signal strengths of the plurality of reflected narrowband sidelink sensing discovery beams. Since the wideband sensing signal is only transmitted in specific directions which have a certain reflected signal strength from the previously transmitted narrowband signal, the resource allocation of the wideband signal and the respective spatial directions is performed in an efficient manner. Thus, the UE according to the first aspect efficiently allocates resources for monostatic sidelink sensing.

In a further possible implementation form of the first aspect, the second plurality of transmit directions is a subset of the first plurality of transmit directions.

In a further possible implementation form of the first aspect, the UE is further configured to determine for each direction of the second plurality of transmit directions a transmission power of the respective wideband sidelink sensing beam based on each of the received signal strengths of the reflected narrowband sidelink sensing discovery beams for the first plurality of transmit directions transmitted in the same direction. Thus, the UE according to this implementation form transmits the wideband sidelink sensing signal in each of the determined directions with the lowest transmission power to perform accurate sensing which advantageously reduces UE power consumption and undue interference to other UEs.

In a further possible implementation form of the first aspect, the UE is configured to determine the transmission power based on a comparison between the corresponding received signal of the reflected signal with at least a first configured or predetermined threshold.

In a further possible implementation form of the first aspect, the UE is configured to transmit, prior to transmitting the plurality of wideband sidelink sensing beams, sidelink control information (SCI) along a third plurality of transmit directions. The SCI may include information about the second plurality of transmit directions. Thus, the UE according to this implementation form informs other nearby receiving UEs about the spatial directions that the UE will subsequently use for the wideband sidelink sensing.

In a further possible implementation form of the first aspect, the third plurality of transmit directions is a subset of the first plurality of transmit directions.

In a further possible implementation form of the first aspect, the SCI about the second plurality of transmit directions is transmitted only in the third plurality of transmit directions which have the same direction as the second plurality of transmit directions.

In a further possible implementation form of the first aspect, the third plurality of transmit directions is the same as the second plurality of transmit directions.

In a further possible implementation form of the first aspect, the third plurality of transmit directions is the same as the first plurality of transmit directions.

In a further possible implementation form of the first aspect, prior to transmitting the plurality of narrowband sidelink sensing discovery beams the UE is further configured to measure a respective received wideband signal strength, such as RSRP, for a plurality of receive directions and to determine the first plurality of transmit directions for the plurality of narrowband sidelink sensing discovery beams based on the plurality of received wideband signal strengths for the plurality of receive directions.

In a further possible implementation form of the first aspect, the plurality of receive directions are isotopically distributed around the UE and the first plurality of transmit directions is a subset of the plurality of receive directions.

In a further possible implementation form of the first aspect, the UE is configured to determine the first plurality of transmit directions for the plurality of narrowband sidelink sensing discovery beams based on the plurality of received wideband signal strengths for the plurality of receive directions by including those directions of the plurality of receive directions in the first plurality of transmit directions for which the received wideband signal strengths are smaller than a second configured or predefined threshold level. Thus, the UE according to this implementation form, only transmits the narrowband sensing signal in spatial directions where there are no transmissions from other UEs.

In a further possible implementation form of the first aspect, the UE is configured to determine a change of position and/or orientation of the UE along a trajectory of the UE and to adjust the second plurality of transmit directions based on the change of position and/or orientation of the UE. Thus, the UE according to this implementation form, adjusts the spatial direction of the wideband sensing beams to compensate for its movement and to illuminate the same area for sensing.

In a further possible implementation form of the first aspect, the UE is configured to continuously repeat monostatic sidelink sensing operations including:
transmitting a plurality of narrowband sidelink sensing discovery beams directed along a first plurality of transmit directions;
measuring a respective received signal strength, such as RSRP, of the plurality of reflected narrowband sidelink sensing discovery beams for the first plurality of transmit directions; and
transmitting a plurality of wideband sidelink sensing beams along a second plurality of transmit directions, where the second plurality of transmit directions are determined based on the first plurality of transmit directions and the plurality of received signal strengths of the plurality of reflected narrowband sidelink sensing discovery beams. Thus, the UE according to this implementation form, repeats all the steps to update the directions of the wideband sidelink sensing signals at regular intervals.

In a further possible implementation form of the first aspect, the UE is further configured to measure a respective received signal strength, such as RSRP, of the plurality of reflected wideband sidelink sensing beams for the second plurality of transmit directions.

In a further possible implementation form of the first aspect, if the UE has changed its position and/or if a received signal strength difference between the received signal strengths of the plurality of reflected narrowband sidelink sensing discovery beams and the received signal strengths of the plurality of reflected wideband sidelink sensing beams for the second plurality of transmit directions is greater than a third predefined threshold level, the UE is configured to:
transmit a further plurality of narrowband sidelink sensing discovery beams directed along a further first plurality of transmit directions;
measure a respective further received signal strength, such as RSRP, of the further plurality of reflected narrowband sidelink sensing discovery beams for the further first plurality of transmit directions; and
transmit a further plurality of wideband sidelink sensing beams along a further second plurality of transmit directions, where the further second plurality of transmit directions are determined based on the further first plurality of transmit directions and the further plurality of received signal strengths of the further plurality of reflected narrowband sidelink sensing discovery beams. Thus, the UE according to this implementation form, updates the directions of the wideband sidelink sensing signals only when the UE has changed its position or when the passive objects in the surrounding environment have moved.

In a further possible implementation form of the first aspect, the configured mode of operation and the thresholds are obtained by the UE or transmitted to the UE from a base station or a second UE. Thus, the UE according to this implementation form, can be configured for monostatic sensing by another device.

According to a second aspect, a method for performing monostatic sidelink sensing with a UE is provided. The method includes:
transmitting a plurality of narrowband sidelink sensing discovery beams directed along a first plurality of transmit directions;
measuring a respective received signal strength of the plurality of reflected narrowband sidelink sensing discovery beams for the first plurality of transmit directions; and
transmitting a plurality of wideband sidelink sensing beams along a second plurality of transmit directions, where the second plurality of transmit directions are determined based on the first plurality of transmit directions and the plurality of received reflected signal strengths of the plurality of reflected narrowband sidelink beams.

In a further possible implementation form of the second aspect, the method further includes determining for each direction of the second plurality of transmit directions a transmission power of the respective wideband sidelink sensing beam based on each of the received signal strengths of the reflected narrowband sidelink sensing discovery beams for the first plurality of beam directions transmitted in the same direction.

In a further possible implementation form of the second aspect, the method further includes, prior to transmitting the plurality of wideband sidelink sensing beams, transmitting sidelink control information (SCI) along a third plurality of transmit directions, where the SCI includes information about the second plurality of transmit directions.

The method according to the second aspect of embodiments can be performed by the UE according to the first aspect of the embodiments. Thus, further features of the method according to the second aspect of the embodiments result directly from the functionality of the UE according to the first aspect of the embodiments as well as its different implementation forms described above and below.

According to a third aspect, a computer program product is provided, including a non-transitory computer-readable storage medium for storing a program code which causes a computer or a processor to perform the method according to the second aspect, when the program code is executed by the computer or the processor.

Details of one or more embodiments are set forth in the accompanying drawings and the description below. Other features, objects, and advantages will be apparent from the description and drawings.

### BRIEF DESCRIPTION OF THE DRAWINGS

In the following, embodiments are described in more detail with reference to the attached figures and drawings, in which:

FIG. 1 shows a schematic diagram illustrating sidelink communications and sidelink sensing with a UE according to an embodiment for performing monostatic sidelink sensing;

FIG. 2 is a flow diagram illustrating steps implemented by a UE according to an embodiment for performing monostatic sidelink sensing;

FIG. 3 shows a schematic diagram illustrating a frame implemented by a UE according to an embodiment for performing monostatic sidelink sensing;

FIG. 4 shows a flow diagram illustrating further steps implemented by a UE according to an embodiment for performing monostatic sidelink sensing;

FIG. 5 shows a flow diagram illustrating steps implemented by a UE according to an embodiment for performing monostatic sidelink sensing in a dynamic scenario;

FIG. 6 shows a schematic diagram illustrating a UE according to an embodiment in a mobile scenario for performing monostatic sidelink sensing;

FIG. 7 shows a flow diagram illustrating steps implemented by a UE according to an embodiment for performing several monostatic sidelink sensing cycles; and

FIG. 8 is a flow diagram illustrating a method according to an embodiment for performing monostatic sidelink sensing with a UE according to an embodiment.

In the following, identical reference signs refer to identical or at least functionally equivalent features.

### DETAILED DESCRIPTION OF THE EMBODIMENTS

In the following description, reference is made to the accompanying figures, which form part of the embodiments, and which show, by way of illustration, specific aspects of embodiments or specific aspects in which embodiments may be used. It is understood that embodiments may be used in other aspects and include structural or logical changes not depicted in the figures. The following detailed description, therefore, is non-limiting.

For instance, it is to be understood that an embodiment in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

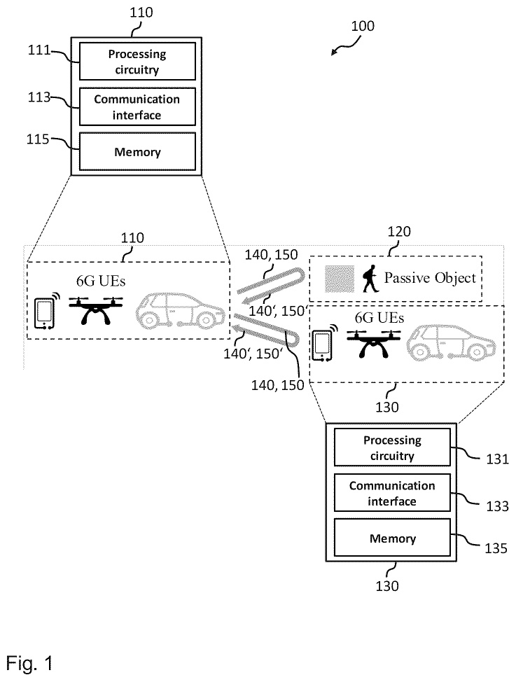

FIG. 1 shows a schematic diagram illustrating a wireless connection 100 with sidelink communications and sidelink sensing including a user equipment (UE) 110 according to an embodiment. The wireless connection 100 may operate based on the 3GPP standard. The wireless connection 100 may further include passive objects 120 and/or other UEs 130. Transmission beams 140, 150 emitted by the UE 110 may hit a surface of the passive objects 120 and/or other UEs 130. Corresponding reflected signals 140′, 150′ may be received by the UE 110.

As illustrated in FIG. 1, the UE 110 may include a processing circuitry 111 and a communication interface 113, such as an antenna, for communicating with the other UEs 130 in the wireless connection 100 as well as for transmitting on the beams 140, 150 and receiving the reflected signals 140′, 150′. The processing circuitry 111 may be implemented in hardware and/or software. The hardware may include digital circuitry, or both analog and digital circuitry. Digital circuitry may include components such as application-specific integrated circuits (ASICs), field-programmable gate arrays (FPGAs), digital signal processors (DSPs), or one or more general-purpose processors. Moreover, the UE 110 may include a memory 115 configured to store executable program code which, when executed by the processing circuitry 111, causes the UE 110 to perform the functions and operations described herein.

Likewise, the other UEs 130 may include a processing circuitry 131 and a communication interface 133 for communicating in the wireless connection 100. The processing circuitry 131 may be implemented in hardware and/or software. The hardware may include digital circuitry, or both analog and digital circuitry. Digital circuitry may include components such as application-specific integrated circuits (ASICs), field-programmable gate arrays (FPGAs), digital signal processors (DSPs), or one or more general-purpose processors. Moreover, the other UEs 130 may include a memory 135 configured to store executable program code which, when executed by the processing circuitry 131, causes the other UEs 130 to perform the functions and operations described herein.

The UE 110 may be any kind of type of UE, such for example a mobile phone, a drone, or a vehicle, for performing autonomous resource allocation for sidelink monostatic sensing. Likewise, the other UEs 110 may be any kind of type of UE, such for example a mobile phone, a drone, a vehicle, or even a base station.

Embodiments herein are directed to the use of monostatic sidelink sensing when the UE 110 needs to perform autonomous resource allocation. This can be very important for safety related applications, where the UE 110 may perform reliable sidelink sensing at all times, and in all coverage scenarios. This is useful for V2x sidelink sensing for detection of other UEs 130 such as for example other vehicles, passive objects 120 and vulnerable road users (VRUs), sensing for service and industrial robots operating outdoors and indoors, and many other types of UEs 110 which need to perform reliable sidelink sensing. As will be appreciated, embodiments described herein may be adopted in future specifications, i.e., 3GPP, of 5G advanced and 6G communication systems.

Monostatic sidelink sensing, where UEs 110 are receiving reflections from their sidelink transmission, can be used in many envisioned sensing use cases in 5G advanced and 6G systems. Example use cases include environment mapping, detection of vehicles and UAVs, vulnerable road user (VRU) protection, intruder detection, remote health monitoring (for example respiration/heart rate measurement), fall detection, and the like.

Further, and as will be described in more detail below, for performing monostatic sidelink sensing, the UE 110 illustrated in FIG. 1 is configured to transmit a plurality of narrowband sidelink sensing discovery beams 140 directed along a first plurality of transmit directions, measure a respective received signal strength, such as RSRP, of the received plurality of reflected narrowband sidelink sensing discovery beams 140′ for the first plurality of transmit directions, and transmit a plurality of wideband sidelink sensing beams 150 along a second plurality of transmit directions. The UE 110 is further configured to determine the second plurality of transmit directions based on the first plurality of transmit directions and the plurality of received signal strengths of the plurality of reflected narrowband sidelink sensing discovery beams 140′.

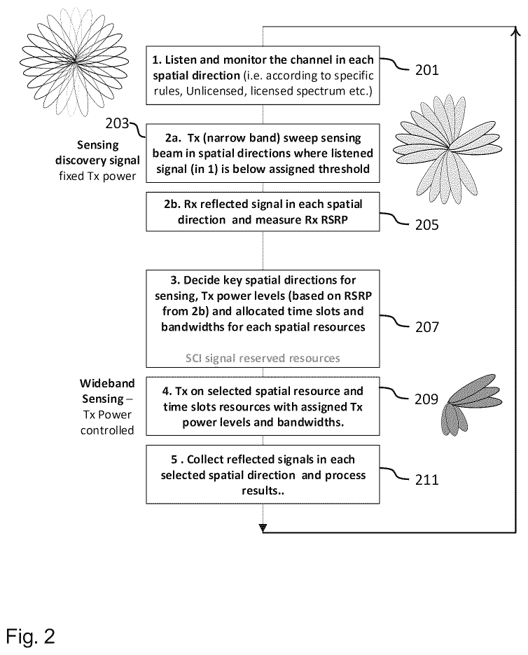

FIG. 2 shows a flow diagram illustrating steps implemented by the UE 110 according to an embodiment for performing monostatic sidelink sensing.

In the step 201 of FIG. 2, the UE 110 may listen in all the spatial directions and in the frequency band that the UE 110 determines to use for wideband sidelink sensing. As an example, FIG. 2 shows all directions in the step 201. Depending upon the rules and procedures for the frequency band, i.e., licensed or unlicensed bands, used, and the set RSRP thresholds levels, the UE 110 may then determine which spatial directions are free from other transmissions.

In the step 203 of FIG. 2, the UE 110 may use the set of free spatial directions established in step 201 of FIG. 2 for transmitting a narrow band discovery signal, i.e., the plurality of narrowband sidelink sensing discovery beams 140 at a fixed transmission power.

In step 205 of FIG. 2, based upon the received RSRP of the plurality of reflected narrowband sidelink sensing discovery beams 140′, for example from possible reflections of passive objects 120, for each of these narrowband spatial directions, the UE 110 may ascertain if objects 120 are located in these spatial directions and also how much minimum Tx power would be needed to illuminate them.

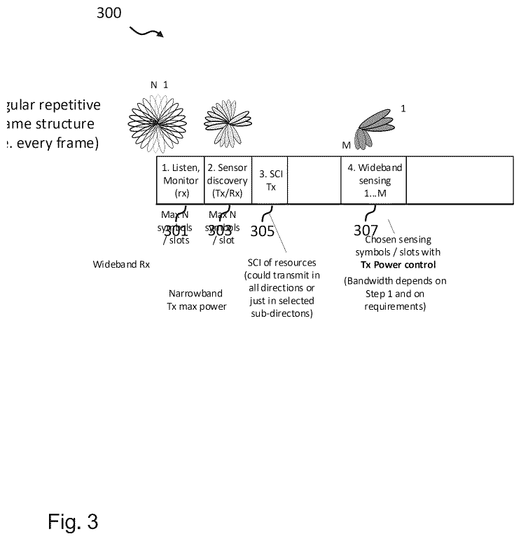

In step 207 of FIG. 2, the results of step 205 may be used by the UE 110 in order to decide the final set of beams 150 for wideband sensing and the minimum amount of transmission power for each of them. Before this final transmission takes place, the UE 110 may signal, for example via sidelink control information (SCI) 305, to all possible receiving UEs 130 the final set of M spatial beams 150 and the corresponding reserved allocated time slots in 307 for these wideband signals that may be used later in a frame 300 (illustrated in FIG. 3). In this way, other UEs 130 may avoid using these resources.

In step 209 of FIG. 2, the UE 110 may perform the transmission of the wideband sensing signal in the selected spatial direction. The received signal from these wideband transmission beams 150, may then give the sensing UE 110 the high accuracy measurements of these passive objects 120, due to the wideband signal used.

In step 211 of FIG. 2, the results of these measurements may be used for further updating of the spatial directions for sensing or the UE 110 may repeat the cycle by repeating step 201 of FIG. 2. As described below, in further embodiments herein, the results of step 209 and 211 may be used for further decision making.

FIG. 3 shows a schematic diagram illustrating a frame 300 implemented by the UE 110 according to an embodiment for performing monostatic sidelink sensing.

The frame 300 may include a regular repetitive frame structure, i.e., for every frame 300 the same frame structure.

The frame 300 may include a first number of slots 301 which may include up to N symbols or slots. The first number of slots 301 may include information regarding the step 201 of FIG. 2 for listening and monitoring on the Rx side, such as related to wideband Rx.

The frame 300 may further include a second number of slots 303 which may include up to N symbols or slots. The second number of slots 303 may include reference signals for the steps 203 and 205 of FIG. 2 for sensing discovery on the Rx and Tx side or the UE.

The frame 300 may further include a third number of slots 305 which may include sidelink control information (SCI) of the reserved resources for the future transmissions in step 209 of FIG. 2. The third number of slots 305 may include information regarding the steps 207 and/or 209 of FIG. 2. This SCI information may be transmitted in all directions or just in selected sub-directions.

The frame 300 may further include a fourth number of slots 307 which may include the chosen M sensing symbols or slots with Tx power control. The fourth number of slots 307 may include a reference signal regarding the step 209 of FIG. 2 related to wideband sensing. The bandwidth of the fourth number of slots 307 may depend on the determination of free spatial directions as well as the requirements of step 201 of FIG. 2.

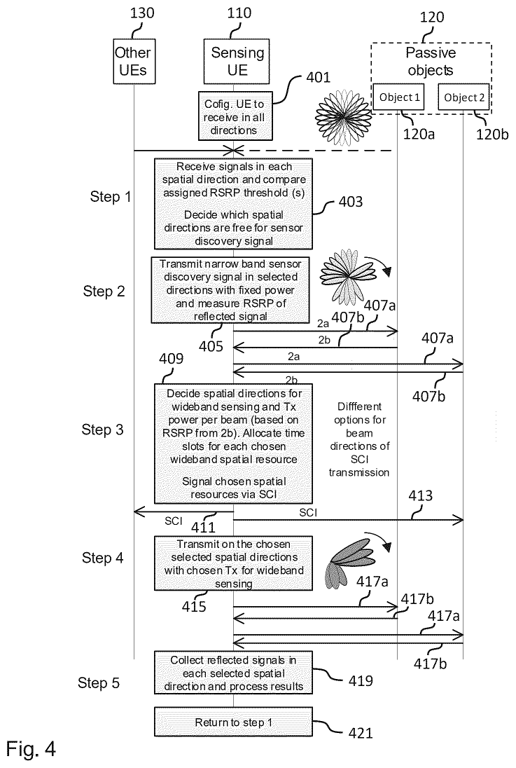

FIG. 4 shows a flow diagram illustrating further steps implemented by the UE 110 according to an embodiment for performing monostatic sidelink sensing.

In step 401 of FIG. 4, the UE 110 may be configured to receive signals from all directions.

In step 403 of FIG. 4, which describes step 201 of FIG. 2 in more detail, the UE 110 may listen to all possible Rx directions for signals transmitted by other UEs 130. For each or these Rx measurement in each of the spatial directions, the receiver bandwidth for step 403 of FIG. 4 may be set by internal requirements for sensing, but a maximum allowed bandwidth for sensing may be set by a pre-configuration parameter Max_SL_SensBandwidth for a given resource pool. A resource pool may be a fixed set of time frequency resources for sidelink. In this way, each UE 110, 130 accessing that resource pool may have the same restrictions.

Furthermore, the UE 110 may use a set of pre-configured RSRP levels to check if the required channel band is free in each Rx direction.

According to a first option of step 403, one RSRP pre-configurations level may be assigned. If the UE 110 receives the signal below a first pre-configured threshold RSRP_Thres_1, the channel may then be assumed to be free in that Rx direction

According to a second option of step 403, two RSRP levels may be assigned. The UE 110 may check if the received signal is above, below or in between two assigned pre-assigned thresholds RSRP_Thres_1 and RSRP_Thres_2. The results of this may determine the transmit power for the sensor discovery signal in the following step 405 of FIG. 4.

If there are very limited time and/or frequency resources available, the bandwidth used for each of the directions may be adaptively set per beam 140, such as when the sensing requirements allow this

In step 405 of FIG. 4, which describes step 203 of FIG. 2 in more detail, the spatial directions used for transmission for the sensor discovery signal may be based on the received signal of the previous listening step(s) 403.

According to a first option of step 405, a Tx spatial direction may be used if the Rx signal in step 403 in the same spatial direction is below the Rx RSRP threshold RSRP_Thres_1 in the band to be used for sensing. The selected Tx per spatial beam 140 may be sent with full Tx power when out of network coverage or Tx power controlled when in network coverage.

According to a second option of step 405 (which may be used if two RSRP thresholds are assigned), if the RSRP of the Rx signal in step 403 in a certain spatial direction is above RSRP_Thres_1 but below another higher RSRP threshold RSRP_Thres_2, the same Tx spatial direction may be used but the Tx power in this direction may be reduced, for example based on actual Rx RSRP—RSRP_Thres_1, compared to normal sidelink power control. If the RSRP of the Rx signal in step 403 in a certain spatial direction is below both RSRP_Thres_1 and RSRP_Thres_2, the same Tx per spatial beam 140 may be sent with full Tx power when out of network coverage or Tx power controlled when in network coverage.

For both the first option of step 405 and the second option of step 405, the narrow band transmission signal used for this sensor discovery signal, may be a dedicated set of resource blocks, different to any dedicated resource blocks assigned to other sidelink signals, i.e., a sidelink synchronization block (SL SSB).

As illustrated by steps 407a and 407b of FIG. 4 the selected directions and corresponding reflected signal strengths of step 405 may include a direction of a first passive object 120a and/or a second passive object 120b of the passive objects 120.

In step 409 of FIG. 4, which describes step 207 of FIG. 2 in more detail, contrary to conventional transmissions for LTE and 5G NR, where the sidelink control information (SCI) transmitted by one UE merely contains information about the time frequency resources that will be subsequently used (or reserved) by that UE, the UE 110 may additionally signal in the SCI signalling the spatial directions that may be subsequently used for the wideband sensing signal in step 415.

According to a first option of step 409, an explicit signalling is performed. If all the SCI information is transmitted in every direction, i.e., so all receiving UEs 130 can receive it, or if only the sensor discovery directions are used for SCI transmissions, the UE 110 may transmit a one-bit indicator in the subset of these SCI beams, that may be used later for wideband sensing in step 415. This may mean that M of the SCI information beams may contain this one bit.

According to a second option of step 409, an implicit signalling is performed. The SCI information may be only sent in the M directions that will be used later in wideband sensing step 415.

The power control for this SCI signal may use the same transmit power that is used for the sensor discovery signal.

As illustrated by steps 411 and 413 of FIG. 4, the SCI beams may be signalled to the further UEs 130 and/or the passive objects 120.

In step 415 of FIG. 4, which describes step 209 of FIG. 2 in more detail, the selected M beam directions for the wideband sensing signal may be transmitted with a beam-based power control based on the Rx RSRP of the received reflected signal (as illustrated in step 407b of FIG. 4) from the sensor discovery signal.

The bandwidth of this wideband sensing signal may be set based on the position accuracy requirements, but it may not exceed the received band which was used in the listening step 403.

As mentioned above for step 403, a maximum allowed sensing bandwidth may be pre-configured according to Max_SL_SensBandwidth for a given resource pool, and if there is very limited time and/or frequency resources available as detected in step 403, the bandwidth used for each of the wideband sensing beams 150 may be adaptively set based on the results of the listening step 403 if the sensing requirements allow this.

As illustrated by steps 417a and 417b of FIG. 4, the transmission of the chosen selected spatial directions of step 415 may include transmissions to and respective reflections from the passive objects 120.

In step 419 of FIG. 4, the UE 110 may collect the reflected signals in each selected spatial direction and process the results.

In step 421 of FIG. 4, the cycle may return to step 401 of FIG. 4.

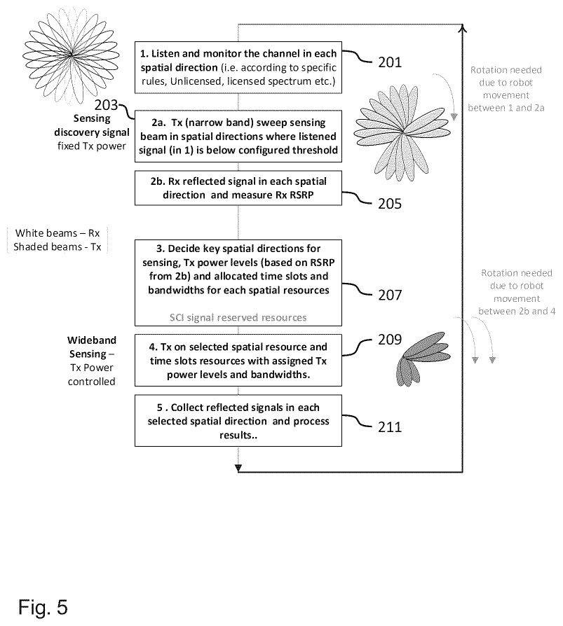

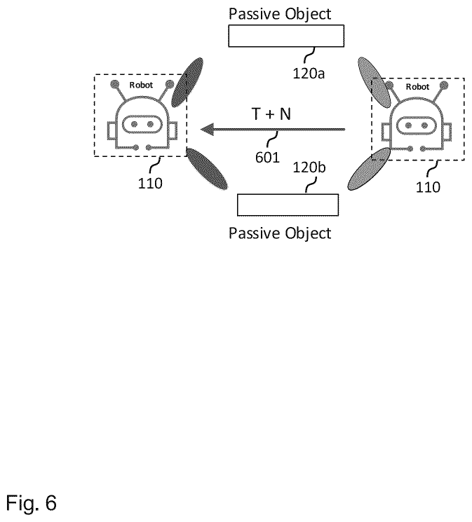

FIG. 5 shows a flow diagram illustrating steps implemented by the UE 110 according to an embodiment for performing monostatic sidelink sensing in a dynamic scenario and FIG. 6 shows a schematic diagram illustrating the UE 110 in the dynamic scenario, i.e., a scenario where the UE 110 is moving. If the trajectory 601 or planned rotational movement of the UE 110 is known, i.e. the UE 110 is a moving UE such as a vehicle, a UAV, a drone, a robot, and the like, the reflected beams 140′ detected in earlier steps may need to be modified when used later. This may be problematic between step 205 and step 209 due to the potential long time between these steps.

As further illustrated in FIG. 6, the trajectory 601 and the rotation of the moving UE 110 may need to be taken into account between the different steps. This is shown in FIG. 5 between step 201 and step 203 and between steps 205 and 207 (and 209).

For example, from the received signal from step 205, the UE 110 may receive an initial rough estimate of the distance between the moving UE 110 and the passive object 120a-b, so this rough estimate, the original Rx beam direction from step 205 and the known trajectory 601 of the UE 110 may be used for rotating the beam 140 for the final wideband sensing.

This may correspond to the final beams 150 to be used in step 209 for the wideband sensing (as signalled in step 207) to be adjusted accordingly.

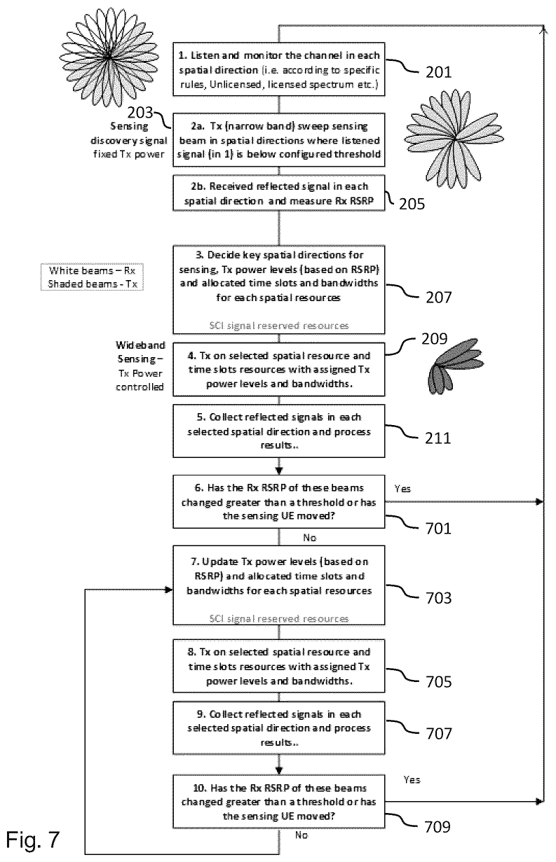

FIG. 7 shows a flow diagram illustrating steps implemented by the UE 110 according to an embodiment for performing two subsequent monostatic sidelink sensing cycles.

In the embodiments above, the cycle of steps may be performed at regular intervals, i.e., at a fixed time slot at every frame 300. However, the complete cycle of steps may not always be needed every frame 300. For example, if the sensing UE 110 and the passive objects 120 are stationary or moving very slowly the set of wideband beams 150 needed for sensing may not need to be changed in the next frame 300.

As illustrated by steps 701 to 709 of FIG. 7, the cycle of steps (starting with step 201) may be re-started at the next frame 300 only if either of the follows conditions holds: (i) the UE 110 performing sensing is moving or has moved since the last listening step 201 or (ii) the normalized received RSRP at step 211 has a very different RSRP, for example greater than RSRP_differ_Thres1, than the corresponding normalized RSRP obtained in the same spatial directions in the preceding sensor discovery step 205. This may imply that the passive objects 120 and/or the UE 110 are moving. Normalized received RSRP in this sense means the received RSRP is adjusted based on the used transmission power. This is important, since the transmission power of the sensing discovery signal in step 203 may be different to the tranmission power of the wideband sensing signal in step 209.

Further, in step 701 of FIG. 7, the UE 110 may check if the Rx RSRP of the reflected signal beams 150′ of step 211 of FIG. 7 changed greater than a threshold such as RSRP_differ_Thres1 or if the sensing UE 110 has moved. If true, the UE 110 may re-start the cycle by returning to step 201 of FIG. 7. If false, the UE 110 may continue with step 703 of FIG. 7.

In step 703 of FIG. 7, the UE 110 may update Tx power levels, such as based on RSRP, and allocated time slots to be used in 307, such as the SCI will signal the reserved resources for 307 in slot 305 of frame 300 together with the bandwidths for each spatial resources that will be used later in step 705. The UE 110 may then continue with step 705 of FIG. 7.

In step 705 of FIG. 7, the UE 110 may, similar to step 209 of FIG. 7, perform transmissions on the selected spatial resource and time slot resources with assigned Tx power levels and bandwidths. The UE 110 may then continue with step 707 of FIG. 7.

In step 707 of FIG. 7, the UE 110 may, similar to step 211 of FIG. 7, collect the reflected signal in each selected spatial direction and process the results. The UE 110 may then continue with step 709 of FIG. 7.

In step 709 of FIG. 7, the UE 110 may compute the difference between the Rx normalised RSRP (A) of the reflected signal beams 150′ of step 707 of FIG. 7, and then the previous received signal 701 (B) to form a new difference value C (C=|A−B|). If this difference value C is larger than a threshold such as RSRP_differ_Thres1 or if the sensing UE 110 has moved the UE 110 may re-start the cycle by returning to step 201 of FIG. 7. If false, the UE 110 may return to step 703 of FIG. 7.

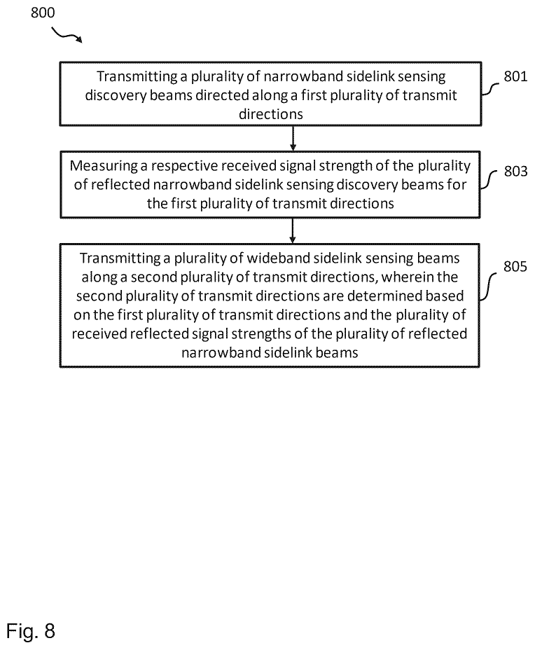

FIG. 8 is a flow diagram illustrating a method 800 according to an embodiment for performing monostatic sidelink sensing with the UE 110.

The method 800 includes a step of transmitting 801 a plurality of narrowband sidelink sensing discovery beams 140 directed along a first plurality of transmit directions.

The method 800 further includes a step of measuring 803 a respective received signal strength of the plurality of reflected narrowband sidelink sensing discovery beams 140′ for the first plurality of transmit directions.

The method 800 further includes a step of transmitting 805 a plurality of wideband sidelink sensing beams 150 along a second plurality of transmit directions, where the second plurality of transmit directions are determined based on the first plurality of transmit directions and the plurality of received reflected signal strengths of the plurality of reflected narrowband sidelink beams 140′

The method 800 can be performed by the UE 110 according to an embodiment. Thus, further features of the method 800 result directly from the functionality of the UE 110 as well as the different embodiments thereof described above and below.

Thus, the UE 110 may determine spatial directions and Tx power per beam 150 for wideband beam-formed sensing signal, such as used for sensing the passive objects 120, based on the received reflected signal 140′ from a previously transmitted narrower band beam formed broadcast signal, i.e. sensor discovery signal. Thus, the UE 110 may transmit the wideband sensing signal only in spatial directions where there are reflecting passive objects 120 and the transmission power for each of these spatial directions may be controlled based on the reflectivity of the passive objects 120.

In this way, only the minimum amount of sidelink transmission resources, in terms of space and power, may be used to perform wideband sensing. This can reduce the potential interference to the other UEs 130, and the power consumption of the sensing UE 110 can be reduced.

The spatial resources to be used by the UE 110 for the wideband beam-formed signal may be indicated in the sidelink control information (SCI) signal. This enables the other UEs 130 to be aware of which spatial resources will be used by the sensing UE 110 later in the frame 300.

The spatial directions used by the UE 110 for the narrow band beam formed broadcast signal, i.e., sensor discovery signal, may be based on the received signal strength of transmissions from other entities such as the other UEs 130 in a previous wideband listening step of the required band. Thus, only a very narrow band signal can be used for discovering the passive objects 120 and the spatial directions used for this signal can avoid any resources occupied by the other UEs 130. This can avoid interfering with the other UEs 130 and can only consume a low bandwidth signal to discover the passive objects 120.

The spatial directions used for the sensor discovery signal and the wideband beam-formed sensing signal, such as the respective SCI signalizing, may be adjusted based on the known trajectory 601 of the UE 110 and initial estimates to the passive objects 120. Thus, spatial resources can be adjusted if the UE 110 moves or has a planned future trajectory 601, for example in the case the UE 110 is a robot moving in a factory or a vehicular UE 110.

The cycle of the steps described above may be restarted if the UE 110 or the passive objects 120 have moved, such as measured based on received RSRP differences. Thus, a re-starting of the cycle of steps can be facilitated only when needed, meaning that the sensor sync signal may not need to be transmitted every frame 300 and the assigned wideband spatial resources may not need to be updated every frame 300.

A person skilled in the art will understand that the “blocks” (“units”) of the various figures (method and apparatus) represent or describe functionalities of embodiments (rather than necessarily individual “units” in hardware or software) and thus describe equally functions or features of apparatus embodiments as well as method embodiments (unit=step).

In the several embodiments provided, it should be understood that the system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments may be integrated into one processing unit, or each of the units may exist alone physically, or two or more units may be integrated into one unit. Further, the embodiments described herein should be considered non-limiting and any modifications or variations made by a person of ordinary skill in the art shall fall within the scope of the embodiments.

1. A user equipment (UE) for performing monostatic sidelink sensing, wherein the UE is configured to:
transmit a plurality of narrowband sidelink sensing discovery beams directed along a first plurality of transmit directions;
measure a respective received signal strength of a plurality of reflected narrowband sidelink sensing discovery beams for the first plurality of transmit directions; and
transmit a plurality of wideband sidelink sensing beams along a second plurality of transmit directions, and
determine the second plurality of transmit directions based on the first plurality of transmit directions and the plurality of received signal strengths of the plurality of reflected narrowband sidelink sensing discovery beams.

2. The UE of claim 1, wherein the second plurality of transmit directions is a subset of the first plurality of transmit directions.

3. The UE of claim 1, wherein the UE is further configured to:
determine for each direction of the second plurality of transmit directions a transmission power of the respective wideband sidelink sensing beam based on each of the received signal strengths of the reflected narrowband sidelink sensing discovery beams for the first plurality of beam directions transmitted in the same direction.

4. The UE of claim 3, wherein the UE is further configured to:
determine the transmission power based on a comparison between the corresponding received signal of a reflected signal with at least a first threshold.

5. The UE of claim 1, wherein the UE is further configured to:
transmit, prior to transmitting the plurality of wideband sidelink sensing beams, sidelink control information, SCI, along a third plurality of transmit directions, wherein the SCI comprises information about the second plurality of transmit directions.

6. The UE of claim 5, wherein the third plurality of transmit directions is a subset of the first plurality of transmit directions.

7. The UE of claim 5, wherein the SCI about the second plurality of transmit directions is transmitted only in the third plurality of transmit directions which have the same direction as the second plurality of transmit directions.

8. The UE of claim 5, wherein the third plurality of transmit directions is the same as the second plurality of transmit directions.

9. The UE of claim 5, wherein the third plurality of transmit directions is the same as the first plurality of transmit directions.

10. The UE of claim 1, wherein prior to transmitting the plurality of narrowband sidelink sensing discovery beams the UE is further configured to:
measure a respective received wideband signal strength for a plurality of receive directions and
determine the first plurality of transmit directions for the plurality of narrowband sidelink sensing discovery beams based on the plurality of received wideband signal strengths for the plurality of receive directions.

11. The UE of claim 10, wherein the plurality of receive directions are isotopically distributed around the UE and wherein the first plurality of transmit directions is a subset of the plurality of receive directions.

12. The UE of claim 10, wherein the UE is further configured to:
determine the first plurality of transmit directions for the plurality of narrowband sidelink sensing discovery beams based on the plurality of received wideband signal strengths for the plurality of receive directions by including those directions of the plurality of receive directions in the first plurality of transmit directions for which the received wideband signal strengths are smaller than a second configured or predefined threshold level.

13. The UE of claim 1, wherein the UE is further configured to:
determine a change of position and/or orientation of the UE and
adjust the second plurality of transmit directions based on the change of position and/or orientation of the UE.

14. The UE of claim 1, wherein the UE is further configured to continuously repeat monostatic sidelink sensing steps comprising:
transmitting a plurality of narrowband sidelink sensing discovery beams directed along a first plurality of transmit directions;
measuring a respective received signal strength of the plurality of reflected narrowband sidelink sensing discovery beams for the first plurality of transmit directions; and
transmitting a plurality of wideband sidelink sensing beams along a second plurality of transmit directions, wherein the second plurality of transmit directions are determined based on the first plurality of transmit directions and the plurality of received signal strengths of the plurality of reflected narrowband sidelink sensing discovery beams.

15. The UE of claim 1, wherein the UE is further configured to:
measure a respective received signal strength of a plurality of reflected wideband sidelink sensing beams for the second plurality of transmit directions.

16. The UE of claim 15, wherein, after the UE has changed its position and/or if a received signal strength difference between the received signal strengths of the plurality of reflected narrowband sidelink sensing discovery beams and the received signal strengths of the plurality of reflected wideband sidelink sensing beams for the second plurality of transmit directions is greater than a third predefined threshold level, the UE is configured to:
transmit a further plurality of narrowband sidelink sensing discovery beams directed along a further first plurality of transmit directions;
measure a respective further received signal strength of the further plurality of reflected narrowband sidelink sensing discovery beams for the further first plurality of transmit directions; and
transmit a further plurality of wideband sidelink sensing beams along a further second plurality of transmit directions, wherein the further second plurality of transmit directions are determined based on the further first plurality of transmit directions and the further plurality of received signal strengths of the further plurality of reflected narrowband sidelink sensing discovery beams.

17. A method for performing a monostatic sidelink sensing cycle with a user equipment, UE, the method comprising:
transmitting a plurality of narrowband sidelink sensing discovery beams directed along a first plurality of transmit directions;
measuring a respective received signal strength of the plurality of reflected narrowband sidelink sensing discovery beams for the first plurality of transmit directions; and
transmitting a plurality of wideband sidelink sensing beams along a second plurality of transmit directions, wherein the second plurality of transmit directions are determined based on the first plurality of transmit directions and the plurality of received signal strengths of the plurality of reflected narrowband sidelink beams.

18. The method of claim 17, further comprising:
determining for each direction of the second plurality of transmit directions a transmission power of the respective wideband sidelink sensing beam based on each of the received signal strengths of the reflected narrowband sidelink sensing discovery beams for the first plurality of beam directions transmitted in the same direction.

19. The method of claim 17, further comprises:
prior to transmitting the plurality of wideband sidelink sensing beams, transmitting sidelink control information, SCI, along a third plurality of transmit directions, wherein the SCI comprises information about the second plurality of transmit directions.

20. A computer program product comprising a non-transitory computer-readable storage medium for storing program code which causes a computer or a processor to perform:
transmitting a plurality of narrowband sidelink sensing discovery beams directed along a first plurality of transmit directions;
measuring a respective received signal strength of the plurality of reflected narrowband sidelink sensing discovery beams for the first plurality of transmit directions; and
transmitting a plurality of wideband sidelink sensing beams along a second plurality of transmit directions, wherein the second plurality of transmit directions are determined based on the first plurality of transmit directions and the plurality of received signal strengths of the plurality of reflected narrowband sidelink beams.
